(19) United States
(12) Patent Application Publication
(10) Pub. No.: US 2008/0251370 A1
(43) Pub. Date: Oct. 16, 2008

(54) SWITCH DEVICE

(75) Inventor: Wataru AOKI, Aichi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: KABUSHIKI KAISHA TOKAI RIKA DENKI SEISAKUSHO, Aichi (JP)

(21) Appl. No.: 12/103,566

(22) Filed: Apr. 15, 2008

(30) Foreign Application Priority Data
Apr. 16, 2007 (JP) 2007-107174

(51) Int. Cl. H01H 1/14

(52) U.S. Cl. 200/534

(57) ABSTRACT

A switch device is provided with an operation key 3 having a first contact portion 315. The operation key 3 is dislocated in a push direction by a push operation. A base member 4 has a second contact portion 41 and a third contact portion 42 electrically conducted by a contact with a first contact portion 315 by the dislocation of the operation key 3 in the push direction. In the base member 4, the second contact portion 41 and the third contact portion 42 are arranged in parallel to each other. A conductive piece 410 projecting toward a third contact portion 42 is connected to the second contact portion 41, and a tip portion of the conductive piece 410 is embedded in the base member 4. A conductive piece 420 projecting toward the second contact portion 41 is connected to the third contact portion 42, and a tip portion of the conductive piece 420 is embedded in the base member 4.

The present application is based on Japanese Patent Application No. 2007-107174 filed on Apr. 16, 2007, the entire contents of which are incorporated herein by reference.

### BACKGROUND OF THE INVENTION

1. Field of the Invention

The present invention relates to a switch device, in more particular, to a switch device provided with a switch operation member (push switch member) to be turned ON (ON-state) by a push operation.

2. Related Art

As one example of conventional switch devices, JP-A-9-92073 discloses a switch device which detects an operation state when, for example, a push operation of a push switch member is conducted by an operator.

The conventional switch device disclosed by JP-A-9-92073 comprises a case having a key top insert hole opened inside and outside of the case, an elastically deformable rubber sheet having a key top as a push switch member penetrating movable into the key top insert hole of the case, and a printed circuit board having a second and third contact portion forming faces corresponding to a first contact portion forming face of the key top in the rubber sheet.

Inside the case, a space for housing a part of the rubber sheet and the printed circuit board etc. is formed.

In the rubber sheet, a first contact portion is formed on the first contact portion forming face of the key top. The rubber sheet is construed to be elastically deformed by the push operation of the key top by the operator, so that the switch device is turned ON (ON-state) by a contact of the first contact portion with a second contact portion and a third contact portion. Furthermore, the rubber sheet is construed to be elastically returned by releasing the push operation of the key top by the operator, so that the switch device is turned OFF (OFF-state) by separating the first contact portion from at least one of the second and third contact portions.

In the printed circuit board, the second and third contact portions (a dimension in a width direction of each of the contact portion is about 0.7 mm) are formed in parallel at a predetermined interval (about 1.5 mm) on the second and third contact portion forming faces respectively, and the second and third contact portions are electrically conducted by the contact with the first contact portion.

According to the structure of the conventional switch device, when the push operation of the key top is conducted, the rubber sheet is elastically deformed to move the key top in a push direction. Therefore, the first contact portion is dislocated in a moving direction of the key top to contact with the second and third contact portions, so that the second and third contact portions are electrically conducted by in accordance with the dislocation of the first contact portion, and the ON-state of the switch device is detected.

Meanwhile, when the push operation of the key top is released, the rubber sheet is elastically returned to move the key top in a direction opposite to the push direction. Therefore, the first contact portion is dislocated in the moving direction of the key top to be separated and distant from at least one of the second and third contact portions, so that the electrical conduction between the second and third contact portions is disconnected, and the OFF-state of the switch device is detected.

However, according to the switch device disclosed by JP-A-9-92073, if the push direction of the key top is shifted in a direction parallel to the second and third contact portions at the time of the push operation, a dislocation direction of the first contact portion is also shifted, so that the first contact portion may not contact with the second and third contact portions. The reason therefore will be explained as below. A dimension between the second and third contact portions (a parallel direction dimension) is designed to be relatively wide (1.5 mm) in order to prevent a generation of a defective electrical conduction due to a dimensional difference (0.05 mm) in a height direction based on a manufacturing error between the second and third contact portions. Therefore, if the dislocation direction of the first contact portion is shifted in the direction parallel to the second and third contact portions, a contact failure between one of the second and third contact portions and the first contact portion is more likely to occur. As a result, there was a problem in that the second and third contact portions are not electrically conducted when detecting the ON-state and it is not possible to securely detect the ON-state.

### THE SUMMARY OF THE INVENTION

Therefore, it is an object of the invention to provide a switch device, by which it is possible to electrically conduct between the second and third contact portions while allowing a displacement of the first contact portion when detecting the ON-state, thereby securely detecting the ON-state.

According to a feature of the present invention, a switch device comprises:

a push switch member comprising a first contact portion, the push switch member being dislocated in a push direction by a push operation; and

a base member comprising a second contact portion and a third contact portion electrically conducted by a contact with the first contact portion by the dislocation of the push switch member in the push direction,

wherein the second contact portion and the third contact portion are arranged in parallel to each other,

wherein a conductive piece projecting toward at least one of the second and third contact portions is connected to another contact portion and a tip portion of the conductive piece is embedded in the base member.

Preferably, the conductive piece is connected to each of the second and third contact portions, and a sum of dimensions of the respective conductive pieces in a projecting direction is determined to be greater than a dimension between the second contact portion and the third contact portion.

Preferably, the push switch member is dislocated in a direction opposite to the push direction by releasing the push operation.

Preferably, the push switch member comprises an operation key comprising a key top and a rubber sheet housed in a device main body.

Preferably, the key top comprises a push-operation face exposed to outside the device main body, and a push-operation force transmitting face for transmitting a push operation power to the rubber sheet, and the key top is mounted on a switch functor and free-fitted in a concave portion and a key top insert hole of the device main body.

Preferably, the rubber sheet comprises a flexible insulating rubber.

Preferably, the rubber sheet comprises a sheet main body and a switch functor, and is arranged beneath the key top.

Preferably, the sheet main body comprises a through hole having a plane and circular shape that is opened along a central axis of the key top insert hole, and is provided on a key top operation side surface of the base member.

Preferably, the switch functor comprises a push-operation force receiving face corresponding to a push-operation force transmitting face, and the switch functor is provided integrally with an upper opening periphery of a through hole in the sheet main body through a skirt-like coupling portion.

Preferably, the first contact portion comprising a conductive rubber is provided at a lower end surface of the switch functor.

Preferably, the base member comprises a concave portion having a plane and circular shape that is opened along a central axis of a through hole, and the base member is arranged beneath the push switch member and housed in a device main body.

Preferably, a second contact portion and a third contact portion that are electrically conducted by a contact with a first contact portion by the dislocation of the push switch member in the push direction are installed to the base member by insert molding.

According to present invention, it is possible to electrically conduct between the second third contact portions while allowing the displacement of the first contact portion when detecting the ON-state, thereby securely providing the ON-state of the switch device.

### BRIEF DESCRIPTION OF THE DRAWINGS

Next, the present invention will be explained in more detail in conjunction with appended drawings, wherein:

FIG. 1 is an explanatory diagram showing a cross section of a total structure of a switch device in a preferred embodiment according to the present invention;

FIG. 2 is an explanatory plan view of a main section of the switch device in the preferred embodiment according to the present invention;

FIG. 3 is an explanatory diagram showing an enlarged cross section of the main section of the switch device in the preferred embodiment according to the present invention; and

FIG. 4A and FIG. 4B are cross sectional views of the switch device for explaining an operation of the switch device in the preferred embodiment according to the present invention.

### DESCRIPTION OF THE PREFERRED EMBODIMENT

### Preferred Embodiment

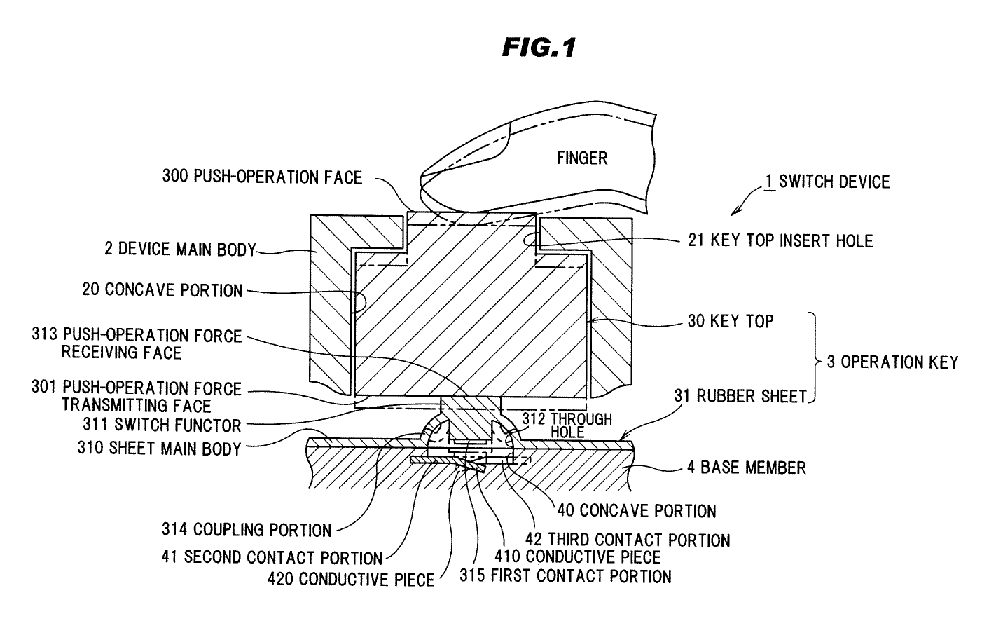

FIG. 1 is an explanatory diagram showing a cross section of a total structure of a switch device in a preferred embodiment according to the present invention.

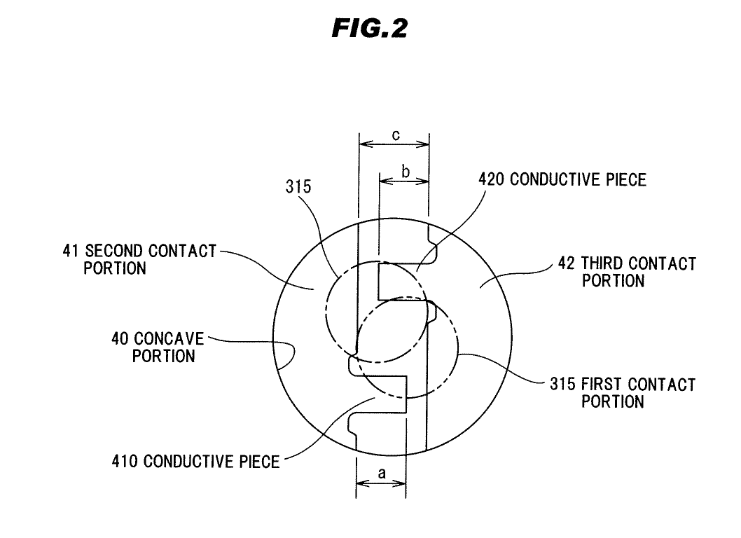

FIG. 2 is an explanatory plan view of a main section of the switch device in the preferred embodiment according to the present invention.

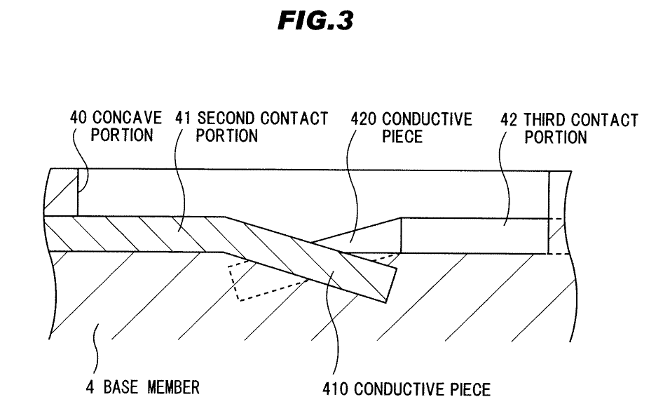

FIG. 3 is an explanatory diagram showing an enlarged cross section of the main section of the switch device in the preferred embodiment according to the present invention.

(Total Structure of a Switch Device)

In FIG. 1, a switch device 1 comprises a device main body 2, an operation key 3 as a push switch member, and a base member 4 for detecting a push operation state of the operation key 3.

(Structure of the Device Main Body 2)

As shown in FIG. 1, the device main body 2 comprises a concave portion 20 that is opened downwards, and a key top insert hole 21 opened inside and outside of the concave portion 20. The device main body 2 comprises, for example, a casing totally composed of a plastic material such as PBT (polybutylene terephthalate) resin or the like.

(Structure of the Operation Key 3)

As shown in FIG. 1, the operation key 3 comprises a key top 30 and a rubber sheet 31, and is housed in the device main body 2.

The key top 30 comprises a push-operation face 300 exposed to outside the device main body 2, and a push-operation force transmitting face 301 for transmitting a push operation power to the rubber sheet 31 (including a switch functor 311 described later). The key top 30 is mounted on the switch functor 311 and free-fitted in the concave portion 20 and the key top insert hole 21 of the device main body 2. Further, the key top 30 is construed to be dislocated in a push direction by a push operation or in an opposite direction by releasing the push operation respectively.

The rubber sheet 31 comprises a sheet main body 310, and the switch functor 311. The rubber sheet 31 is arranged beneath the key top 30. The rubber sheet 31 is totally composed of a plastic material comprising a flexible insulating rubber such as silicone.

A sheet main body 310 comprises a through hole 312 having a plane and circular shape that is opened along a central axis of the key top insert hole 21. The sheet main body 310 is provided on a key top operation side surface (an upper surface) of a base member 4.

The switch functor 311 comprises a push-operation force receiving face 313 which corresponds to the push-operation force transmitting face 301. The switch functor 311 is provided integrally with an upper opening periphery of the through hole 312 in the sheet main body 310 through a skirt-like coupling portion (thin wall part) 314. The switch functor 311 is construed to be dislocated to a position of the ON-state by the elastic deformation of the coupling portion 314 by the push operation of the key top 30, and to be returned to a position of the OFF-state (an initial position) by the elastic deformation of the coupling portion 314 by releasing the push operation. At a lower end surface (a surface opposite to the push-operation force receiving face 313) of the switch functor 311, a first contact portion 315 comprising a conductive rubber is provided.

(Structure of the Base Member 4)

As shown in FIG. 1, the base member 4 comprises a concave portion 40 having a plane and circular shape that is opened along a central axis of the through hole 312. The base member 4 is arranged beneath the operation key 3 and housed in the device main body 2. The base member 4 is totally composed of, for example, a plastic material (PBT resin etc.) which is same as the material of the device main body 2. To the base member 4, a second contact portion 41 and a third contact portion 42 that are electrically conducted by a contact with the first contact portion 315 by the dislocation of the operation key 3 (key top 30) in the push direction are installed by insert molding. Furthermore, in the base member 4, an ON/OFF-state detecting circuit (not shown) connected to the second contact portion 41 and the third contact portion 42 is provided.

As shown in FIG. 2, the second contact portion 41 and third contact portion 42 are provided in parallel at a predetermined interval (about 1.5 mm) respectively, and each of the second contact portion 41 and third contact portion 42 is totally composed of a metal material, for example, copper (Cu).

The second contact portion 41 is embedded in the base member 4 to expose a portion in an opening surface of the concave portion 40. A conductive piece 410 projecting toward the third contact member 42 is connected to an exposed side of the second contact portion 41 in the state that the conductive piece 410 is bent to an opposite side with respect to the key top 30.

As shown in FIG. 3, the conductive piece 410 comprises an inclined piece having a base end portion exposed in the opening surface of the concave portion 40 (a first contact portion side) and a tip portion embedded in the base member 4. According to this structure, even if the dislocation direction of the first contact portion 315 is shifted to a side adjacent to the third contact portion 42 at the time of the push operation, it is possible to contact the conductive piece 410 with the first contact portion 315 on the side adjacent to the third contact portion 42. Furthermore, it is possible to prevent the conductive piece 410 from warping deformation toward the key top side.

Similarly to the second contact portion 41, the third contact portion 42 is embedded in the base member 4 to expose a portion in the opening surface of the concave portion 40. A conductive piece 420 projecting toward the second contact member 41 is connected to an exposed side of the third contact portion 42 in the state that the conductive piece 420 is bent to an opposite side with respect to the key top 30.

As shown in FIG. 3, similarly to the conductive piece 410, the conductive piece 420 comprises an inclined piece having a base end portion exposed in the opening surface of the concave portion 40 (the first contact portion side) and a tip portion embedded in the base member 4. According to this structure, even if the dislocation direction of the first contact portion 315 is shifted to a side adjacent to the second contact portion 41 at the time of the push operation, it is possible to contact the conductive piece 420 with the first contact portion 315 on the side adjacent to the second contact portion 41. Furthermore, it is possible to prevent the conductive piece 420 from warping deformation toward the key top side.

As shown in FIG. 2, the conductive pieces 410 and 420 are arranged in parallel to each other at a predetermined interval in a direction orthogonal to the parallel direction of the second contact portion 41 and third contact portion 42, in which a dimension (a+b), which is a sum of projecting direction dimensions a and b of the respective portions exposed to the first contact portion side, is determined to be greater than a dimension c (a parallel direction dimension) between the second contact portion 41 and the third contact portion 42 (i.e. a+b>c). As a result, even if the push direction of the key top 30 is shifted to the parallel direction of the second contact portion 41 and the third contact portion 42 at the time of the push operation, it is possible to contact the first contact portion 315 indicated by a dashed line in FIG. 2 over the second contact portion 41 and the conductive piece 410, or to contact the first contact portion 315 indicated by a two-dot chain line in FIG. 2 over the third contact portion 42 and the conductive piece 420 by allowing the displacement effectively.

Preferably, the width direction dimensions of the second contact portion 41 and the third contact portion 42 are determined to be maximum as possible (greater than 0.7 mm) to prevent generation of distortional deformation by applying a bending processing to the conductive pieces 410 and 420.

(Operation of the Switch Device 1)

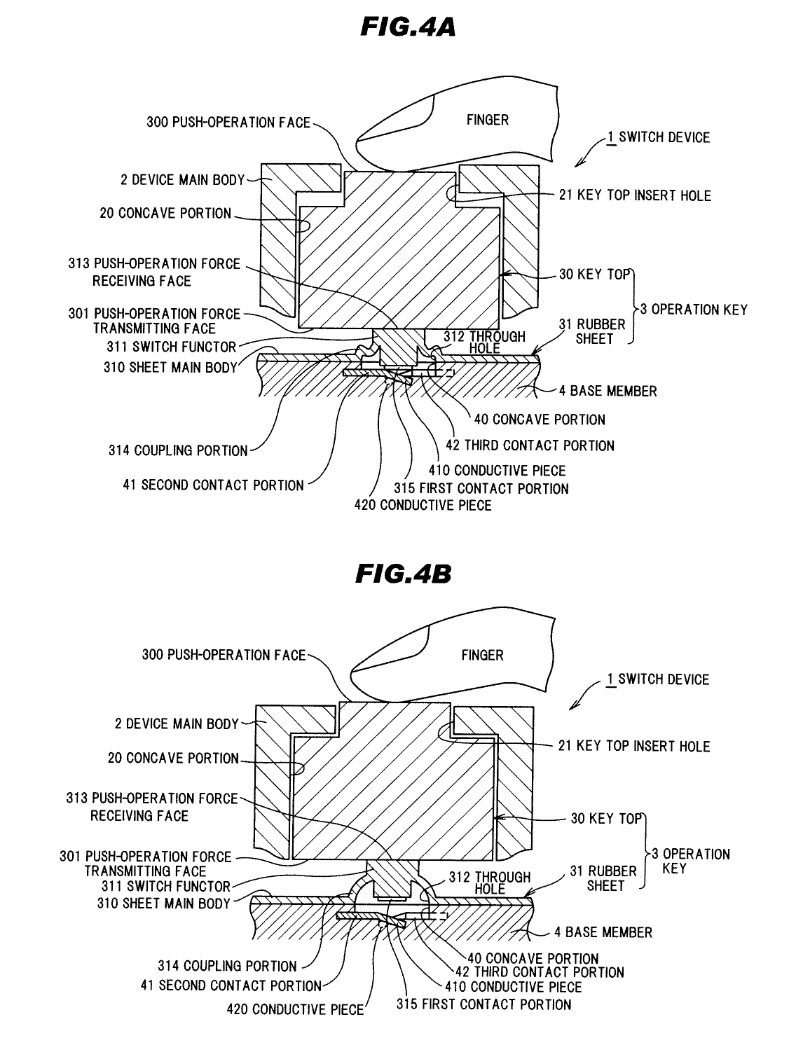

FIG. 4A and FIG. 4B are cross sectional views of the switch device for explaining an operation of the switch device in the preferred embodiment according to the present invention, where FIG. 4A shows a state that the push operation is conducted and FIG. 4B shows a state that the push operation is released, respectively.

### (Push Operation)

As shown in FIG. 4A, when the push-operation face 300 of the key top 30 is push-operated by a finger of the operator in the OFF-state, the key top 30 is moved downwards to press the switch functor 311 (a direction to approach the second contact portion 41 and the third contact portion 42), the coupling portion 314 is elastically deformed to be bent. Then, the switch functor 311 is moved downwards, so that the first contact portion 315 contacts over the second contact portion 41 and the third contact portion 42. In this case, even if the push direction of the key top 30 is shifted in the parallel direction of the second contact portion 41 and the third contact portion 42 and the dislocation direction of the first contact portion 315 is shifted, the first contact portion 315 contacts over the second contact portion 41 and the conductive piece 420 or the third contact portion 42 and the conductive piece 410. Therefore, the second contact portion 41 and the third contact portion 42 are electrically conducted, so that the ON/OFF-state detecting circuit detects the ON-state.

(Release of the Push Operation)

As shown in FIG. 4B, when the push operation by the finger of the operator to the push-operation face 300 of the key top 30 is released in the ON-state, the pressing state to the push-operation face 300 by the key top 30 is released, and the coupling portion 314 is elastically deformed (returned) to an elongated state (the initial state). Then, the switch functor 311 is moved upwards (the direction to be separated and distant from the second contact portion 41 and the third contact portion 42), so that the contact state of the first contact portion 315 with the second contact portion 41 and the third contact portion 42 is released. Therefore, the electrical conduction between the second contact portion 41 and the third contact portion 42 is disconnected, and the ON/OFF-state detecting circuit detects the OFF-state.

### Effect of the Embodiment

In the preferred embodiment according to the present invention explained above, following effects can be obtained.

(1) Even if the push direction of the key top 30 is shifted in the parallel direction of the second contact portion 41 and the third contact portion 42 so that the dislocation direction of the first contact portion 315 is shifted, it is possible to contact the first contact portion 315 over the second contact portion 41 and the conductive piece 420 or to contact the third contact portion 42 and the conductive piece 410 by allowing the displacement of the first contact portion 315. As a result, it is possible to electrically conduct between the second contact portion 41 and the third contact portion 42 when detecting the ON-state and to securely detect the ON-state.

(2) Since the conductive pieces 410 and 420 are construed such that the dimension (a+b), which is a sum of projecting direction dimensions a and b of the respective portions exposed to the first contact portion side, is determined to be greater than the dimension c between the second contact portion 41 and the third contact portion 42 (i.e. a+b>c), it is possible to widen an allowable range of the displacement in the push direction by the key top 30 with respect to the parallel direction of the second contact portion 41 and the third contact portion 42.

Although the switch device according to the present invention has been described based on the above preferred embodiment, the invention is not to be limited by the above preferred embodiment and it is possible to implement in various features without going beyond a scope of the concept. For example, following variations can be made.

(1) In this preferred embodiment, although it is explained that the conductive piece 410 projecting toward the third contact portion 42 is connected to the second contact portion 41, and the conductive piece 420 projecting toward the second contact portion 41 is connected to the third contact portion 42, respectively, the present invention is not limited thereto. Hence, a conductive piece projecting toward the third contact portion may be connected to the second contact portion, or a conductive piece projecting toward the second contact portion may be connected to the third contact portion. Namely, according to the present invention, the conductive piece projecting toward at least one of the second and third contact portions is connected to another contact portion in the state the tip portion of the conductive piece is embedded in the base member.

(2) In this preferred embodiment, although the application for the switch device comprising a single operation key 3 is explained, the present invention is not limited thereto. Hence, it is possible to apply the present invention to the switch device comprising a plurality of operation keys. In this case, for example, a plurality of switch portions (a plurality of second contact portions and a plurality of third contact portions) corresponding to a plurality of operation keys are provided in the base member of the switch device.

(3) In this preferred embodiment, although it is explained that respective parts such as the base member 4 are composed of the plastic material such as PBT resin and the like, the present invention is not limited thereto. Hence, the respective parts may comprise other plastic materials or materials other than the plastic materials.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A switch device comprising:
a push switch member comprising a first contact portion, the push switch member being dislocated in a push direction by a push operation; and
a base member comprising a second contact portion and a third contact portion electrically conducted by a contact with the first contact portion by the dislocation of the push switch member in the push direction,
wherein the second contact portion and the third contact portion are arranged in parallel to each other,
wherein a conductive piece projecting toward at least one of the second and third contact portions is connected to another contact portion and a tip portion of the conductive piece is embedded in the base member.

2. The switch device according to claim 1, wherein the conductive piece is connected to each of the second and third contact portions, and a sum of dimensions of the respective conductive pieces in a projecting direction is determined to be greater than a dimension between the second contact portion and the third contact portion.

3. The switch device according to claim 1, wherein the push switch member is dislocated in a direction opposite to the push direction by releasing the push operation.

4. The switch device according to claim 1, wherein the push switch member comprises an operation key comprising a key top and a rubber sheet housed in a device main body.

5. The switch device according to claim 4, wherein the key top comprises a push-operation face exposed to outside the device main body, and a push-operation force transmitting face for transmitting a push operation power to the rubber sheet, and the key top is mounted on a switch functor and free-fitted in a concave portion and a key top insert hole of the device main body.

6. The switch device according to claim 4, wherein the rubber sheet comprises a flexible insulating rubber.

7. The switch device according to claim 4, wherein the rubber sheet comprises a sheet main body and a switch functor, and is arranged beneath the key top.

8. The switch device according to claim 7, wherein the sheet main body comprises a through hole having a plane and circular shape that is opened along a central axis of the key top insert hole, and is provided on a key top operation side surface of the base member.

9. The switch device according to claim 7, wherein the switch functor comprises a push-operation force receiving face corresponding to a push-operation force transmitting face, and the switch functor is provided integrally with an upper opening periphery of a through hole in the sheet main body through a skirt-like coupling portion.

10. The switch device according to claim 7, wherein the first contact portion comprising a conductive rubber is provided at a lower end surface of the switch functor.

11. The switch device according to claim 1, wherein the base member comprises a concave portion having a plane and circular shape that is opened along a central axis of a through hole, and the base member is arranged beneath the push switch member and housed in a device main body.

12. The switch device according to claim 1, wherein a second contact portion and a third contact portion that are electrically conducted by a contact with a first contact portion by the dislocation of the push switch member in the push direction are installed to the base member by insert molding.
